(19) United States
(12) Patent Application Publication
(10) Pub. No.: US 2021/0224337 A1
(43) Pub. Date: Jul. 22, 2021

(54) METHOD AND SYSTEM FOR INFORMING CONTENT WITH DATA

(71) Applicant: STARCOM MEDIAVEST GROUP, Chicago, IL (US)

(72) Inventor: Caroline BALLARD, Chicago, IL (US)

(21) Appl. No.: 17/223,775

(22) Filed: Apr. 6, 2021

Related U.S. Application Data
(63) Continuation-in-part of application No. 14/885,681, filed on Oct. 16, 2015, now abandoned.
(60) Provisional application No. 62/218,720, filed on Sep. 15, 2015.

(51) Int. Cl. G06F 16/951; G06F 16/9537; G06F 16/9536

(52) U.S. Cl. CPC G06F 16/951; G06Q 30/0256; G06F 16/9536; G06F 16/9537

(57) ABSTRACT

A computer-implemented method is provided for identifying trends. An exemplary method includes: receiving search data indicative of a plurality of searches conducted; categorizing the search data based on a plurality of categories of goods or services or information; receiving a first input indicative of at least one of the categories; receiving search engine data relating to searches relevant to the category; comparing the search engine data to historical search engine data associated with a different time period to determine an anticipated trend for a coming time period; generating a plurality of visual representation; selecting a first term; selecting a second term; collecting a plurality of conversational information; determining whether a select number of the conversational information are related; collecting related content information; determining trends over time data; and displaying a third visual representation of the plurality of visual representations indicating trends over time using the trends over time data.

### 1. CROSS REFERENCE TO RELATED APPLICATION

This application is a continuation-in-part of U.S. application Ser. No. 14/885,681 filed on Oct. 16, 2015, which claims benefit of and priority to U.S. Provisional Application No. 62/218,720 filed on Sep. 15, 2015, the contents of all of which are hereby incorporated by reference in their entirety.

### 2. FIELD OF THE INVENTION

The present invention relates to a system and method for identifying trends for use in advertising by using search engine and social media data and displaying the resulting information in a usable way on a computer display.

### 3. GENERAL BACKGROUND

Many people are increasingly relying on World Wide Web resource to obtain information. By observing data regarding searches performed on search sites and social insightsinto areas of interest to people, trends that are highly useful, timely, and relevant to companies wishing to reach consumers through targeted advertising can be identified. However, because the manual process of identifying trends is so time consuming, trends can be missed due to 45 delays in gathering data. Furthermore, manual analysis is not scalable as necessary for large, complex companies.

Some search data are currently available, but not in a form that is useful for content planning. For example, Google Trends provides trends for Google search properties (e.g., web search, image, news, shopping, and YouTube). Google Trends is a public web facility of Google, Inc., based on GoogleSearch that shows how often a particular search term is entered relative to the total search volume across various regions of the world, and in various languages.

Other companies also have tools that use data (such as Google AdWords) to build out broad paid search campaigns or focus on aggregation. Such companies/tools include Ardent I/O and Crimson Hexagon. However, like Google Trends, these tools may not be useful for informing content because they only focus on either search or social data, rather than combining both. Therefore, what is needed is a content planning tool built on search engine data and social insights to anticipate trends within minutes rather than days. The result should be usable to provide targeted content in multiple channels, such as search, digital, website, & social creative. For example, digital creative could be a banner ad; social creative could be a post on Facebook or Twitter.

### SUMMARY

It may be desirable for a user who wishes to identify consumer trends for the purpose of providing informed content to target potential customers to be able to identify trends on an up to the minute basis rather than longer term. It may also be useful for the user to compare a trending search to the same time period a year ago (as just one example) or to see visually if the trend is increasing or decreasing over different time periods.

In a first principal aspect, an exemplary embodiment of the present invention provides a computer-implemented method for identifying trends (such as consumer trends). The method comprises receiving an input that indicates a category of goods or services to create a set of relevant terms. Once a set of relevant terms is created, search engine data may be received for a given date range, where the data relates to searches for the goods or services in the category. The search engine data may comprise search terms and volume data for the search terms. Multiple search terms related to the category can then be weighted using, for example, volume data, and geographic data. Once the search terms are weighted, a visual display can be generated based on the weighting. As an example, the visual display may be a word cloud, where the higher-weighted terms may appear larger, or in a different font, or be a different color than lower-weighted words. The terms may also have different positions based on their weights. Alternatively, the visual display may be in the form of a sorted data table, or it may be a comparison to terms from a different time period, such as a previous year.

In a second principal aspect, an exemplary embodiment further includes receiving a second input indicating a user selection of a first term in the word cloud and generating a secondset of relevant terms. As an example, the second set of terms could be a subset of the selected first term from the first visual display. Using the selection and the search engine data, the second set of terms can be weighted, again using volume or other criteria, and a second visual display can be generated based on the weighting. Again, the second visual display may be a word cloud where the different terms have different sizes, fonts, colors, or positions, or some combination of these based on their weights. The second visual display may also be in the form of a sorted list or a comparison. The second visual display (or the first visual display) may also be in the form of a map indicating the popularity of the first selected term by geography, or a chart indicating the popularity by demographic. The second visual display may be displayed next to or near the first, for example on a single user's computer screen.

In a third principal aspect, an exemplary embodiment of the method additionally includes receiving a third input indicating a user selection of a second term from the second visual display. The method may further include generating a third visual display comprising a comparison of the selected data. For example, the third visual display may comprise a line graph of the trends of the category of goods or services, the first term selected from the first visual display, and the second term selected from the second visual display. The third visual display may be displayed simultaneously with the first and second visual displays. For example, it may be displayed in a window below (or near) the first and second visual displays on a computer screen.

In a fourth principal aspect, usable with the previously described three principal aspects (in any combination), an exemplary embodiment of the method additionally includes receiving data from Social partners (e.g., Twitter, blogs, or news article mentions of keywords, hashtags, and keywords searched), again relating to the goods or services in the selected category, for the given date range. Once the Social data is received, it can be used in combination with the search engine data to create the weighted terms, and thus affect the results displayed in the first, second, and third visual displays.

In a fifth principal aspect, an exemplary embodiment of the invention includes a computer program product comprising a computer usable medium having readable program code embodied in the medium, wherein the computer program product includes at least one component to carry out the steps in the previously described four principal aspects. These as well as other aspects and advantages of the present invention will become apparent to those of ordinary skill in the art by reading the following detailed description, with appropriate reference to the accompanying drawings.

According to one aspect of the subject matter described in this disclosure, a computer-implemented method for identifying trends is provided. The method includes the following: receiving search data indicative of a plurality of searches conducted; categorizing the search data based on a plurality of categories of goods or services or information; receiving a first input indicative of at least one of the categories; receiving search engine data relating to searches relevant to the category, the search engine data comprising first search terms and first volume data for the first search terms; comparing the search engine data to historical search engine data associated with a different time period to determine an anticipated trend for a coming time period; generating a plurality of visual representations, wherein the first search terms are displayed in a first visual representation of the plurality of visual representations; selecting a first term from the first search terms displayed in the first visual representation; selecting a second term from a second set of terms associated with the first search terms displayed in a second visual representation of the plurality of visual representations; collecting a plurality of conversational information from one or more external sources; determining whether a select number of the conversational information are related to the first term or the second term; in response to determining the selected number of the conversational information, collecting related content information associated with the select number of the conversational information; determining trends over time data from the results of comparing the search engine data to historical search engine data associated with the different time period and the related content information; and displaying a third visual representation of the plurality of visual representations indicating trends over time using the trends over time data.

According to one aspect of the subject matter described in this disclosure, a non-transient computer readable medium containing program instructions is provided. The program instructions causing a computer to perform the steps of: receiving search data indicative of a plurality of searches conducted; categorizing the search data based on a plurality of categories of goods or services or information; receiving a first input indicative of at least one of the categories; receiving search engine data relating to searches relevant to the category, the search engine data comprising first search terms and first volume data for the first search terms; comparing the search engine data to historical search engine data associated with a different time period to determine an anticipated trend for a coming time period; generating a plurality of visual representations, wherein the first search terms are displayed in a first visual representation of the plurality of visual representations; selecting a first term from the first search terms displayed in the first visual representation; selecting a second term from a second set of terms associated with the first search terms displayed in a second visual representation of the plurality of visual representations; collecting a plurality of conversational information from one or more external sources; determining whether a select number of the conversational information are related to the first term or the second term; in response to determining the selected number of the conversational information, collecting related content information associated with the select number of the conversational information; determining trends over time data from the results of comparing the search engine data to historical search engine data associated with the different time period and the related content information; and displaying a third visual representation of the plurality of visual representations indicating trends over time using the trends over time data.

### BRIEF DESCRIPTION OF THE DRAWINGS

Exemplary embodiments of the present invention are described herein with reference to the drawings, in which:

FIG. 1 is a simplified diagram that illustrates a system m which the exemplary embodiments can be employed;

FIG. 2A is a screenshot displaying an exemplary user interface usable in accordance with the exemplary embodiments;

FIG. 2B is another screenshot displaying an exemplary user interface usable in accordance with the exemplary embodiments;

FIG. 2C is another screenshot displaying an exemplary user interface usable in accordance with the exemplary embodiments;

FIG. 2D is another screenshot displaying an exemplary user interface usable in accordance with the exemplary embodiments;

FIG. 2E is another screenshot displaying an exemplary user interface usable in accordance with the exemplary embodiments;

FIG. 2F is another screenshot displaying an exemplary user interface usable in accordance with the exemplary embodiments;

FIG. 2G is another screenshot displaying an exemplary user interface usable in accordance with the exemplary embodiments;

FIG. 2H is another screenshot displaying an exemplary user interface usable in accordance with the exemplary embodiments;

FIG. 2I is another screenshot displaying an exemplary user interface usable in accordance with the exemplary embodiments;

FIG. 3 is a flow chart of functions that may be carried out in accordance with the exemplary embodiments;

FIG. 4 is an illustration of the Technical Inputs and User Outputs that may be used in accordance with the exemplary embodiments.

FIGS. 5A and 5B illustrate a flow chart of a computer-implemented method for identifying trends in accordance with the exemplary embodiments.

### DETAILED DESCRIPTION OF EXEMPLARY

### Embodiments

The system and method described here is called “Compass” by the inventor's company, Starcom. Compass is a planning tool built on search & social insights to anticipate trends within minutes, not days. Compass is for all verticals, and can thus be used for any type of trend, such as showing category trends in food, travel, automotive, retail, etc. Compass uses search & social insights to inform several channels, such as search, digital, website, & social creative.

Because the manual process has been so time consuming, teams have often missed trends due to delays in gathering data. It's not scalable across large, complex clients. Compass has yielded positive results every time against core KPIs (Key Performance Indicators). The automated, web-based solution identifies trends for users in a scalable way. Compass triangulates a vast amount of data into a very simple view to digest & act on it to create precision content.

### Compass

### Examples

Bologna Day 2014

This is the first time Compass was used. Historical data from search engines showed that when users search for the Bologna category in October, they are often searching for Bologna Cake, a recipe involving several Kraft ingredients. This was used in a Tweet for Bologna day & ran against 2 other pieces of copy not related to trending topics. Within 2 hours, this was the clear winner in terms of the engagement KPI. It is the best performing tweet Kraft has seen in Twitter.
Results below:
200,000 Engagements
4× higher engagement rate than average

Thanksgiving 2014

Historical data from search engines & social partners showed that consumers are interested in cranberry recipes October-November With Compass, a user can dig one level lower and see what types of cranberry recipes trending are. It was uncovered that consumers are interested in savory recipes, not sweet. This explained why the sweet cranberry cupcake recipe was not performing well in display ads for a dessert campaign. As a result, it was replaced with a sweet recipe that was trending—chocolate pumpkin. When that was done, for the target demographic, Millennials, showed the results below:
+10% lift in Purchase Intent
+11% lift in Brand Favorability

### Compass Process Flow: Technical

| Search Engine Data | Social/Blog Data |
|---|---|
| 1. Define category to pull in | 1. Define category to pull |
| relevant terms | in relevant terms |
| 2. Search engines provide data for | 2. Social partners provide |
| given date range | data for given date range |
| 3. Data is sent to user/application | 3. Data is sent to user/application |
| for user consumption | for user consumption |

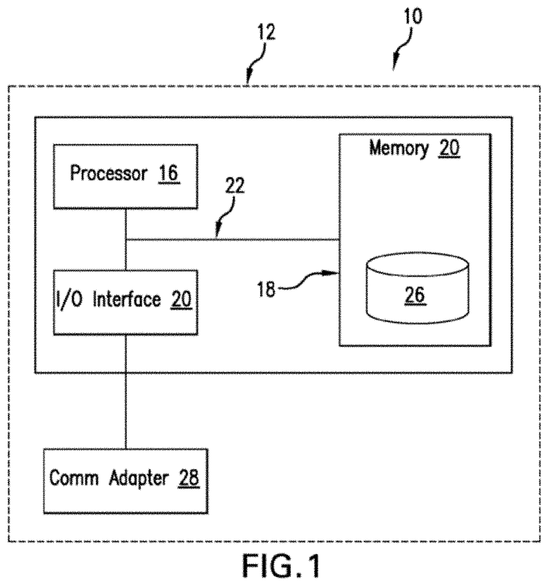

FIG. 1 shows a system 10 in which the exemplary embodiments can be implemented. The system 10 may include a server 12 that can perform some or all of the processes described here. The server 12 includes a computing device 14 that further includes a processor 16, storage 18, and an input/output (I/O) interface 20, and a communications bus 22. The bus 22 connects to and enables communication between the processor 16 and the components of the computing device 14 in accordance with known techniques. Note that in some computing devices there maybe multiple processors incorporated therein.

The processor 16 communicates with storage 18 via the bus 22. Memory 24, such as Random Access Memory (RAM), Read Only Memory (ROM), flash memory, etc. is directly accessible while secondary storage device 26, such as a hard disk or disks (which may be internal or external), is accessible with additional interface hardware and software as is known and customary in the art. Note that a computing device 14 may have multiple memories (e.g., RAM and ROM), secondary storage devices, and removable storage devices (e.g., USB drive and optical drive).

The server 12 may also communicate with other computing devices, computers, workstations, etc. or networks thereof through a communications adapter 28, such as a telephone, cable, or wireless modem, ISDN Adapter, DSL adapter, Local Area Network (LAN) adapter, or other communications channel. Note that the server 12 may use multiple communication adapters for making the necessary communication connections (e.g., a telephone modem card and a LAN adapter). The server 12 may be associated with other computing devices in a LAN or WAN. All these configurations, as well as the appropriate communications hardware and software, are known in the art.

The computing device 14 provides the facility for running software, such as Operating System software and Application software. Note that such software executes tasks and may communicate with various software components on this and other computing devices.

As will be understood by one of ordinary skill in the art, computer programs such as that described herein are typically distributed as part of a computer program product that has a computer useable media or medium containing or storing the program code. Therefore, “media”, “medium”, “computer useable medium”, or “computer useable media”, as used herein, may include a computer memory (RAM and/or ROM), a diskette, a tape, a compact disc, a DVD, an integrated circuit, a programmable logic array (PLA), a remote transmission over a communications circuit, a remote transmission over a wireless network such as a cellular network, or any other medium useable by computers with or without proper adapter interfaces. Note that examples of a computer useable medium include but are not limited to palpable physical media, such as a CD Rom, diskette, hard drive and the like, as well as other non-palpable physical media, such as a carrier signal, whether over wires or wireless, when the program is distributed electronically.

Although the enabling instructions might be “written on” a diskette or tape, “stored in” an integrated circuit or PLA, “carried over” a communications circuit or wireless network, it will be appreciated, that for purposes of the present invention described herein, the computer useable medium will be referred to as “bearing” the instructions, or the instructions (or software) will be referred to as being “on” the medium. Thus, software or instructions “embodied on” a medium is intended to encompass the above and all equivalent ways in which the instructions or software can be associated with a computer useable medium.

For simplicity, the term “computer program product” is used to refer to a computer useable medium, as defined above, which bears or has embodied thereon any form of software or instructions to enable a computer system (or multiple cooperating systems) to operate according to the above-identified invention.

In general, the server 12 may receive data from search engines, social networks, blogs, etc., relating to categories of goods or services. The categories of goods or services, as well as dates of interest, can be input by a user at a computer or computing device located remotely from server 12, communicating with server 12 over the Internet or other network. The system may be useful for different purposes and users, but in the examples here, the user would be a seller who would like to provide, for example, “content” through various media channels, and have that content be highly relevant to the target audience.

An exemplary process for implementing the system is outlined below:

Step 1:

Search: Billions of searches are made every day on computer devices. Searches are recorded and Total Search Volume by keyword are gathered by engines. Monthly search volume, as well as daily/weekly trends are accessible.

Social: Similarly, users search for & talk about keywords online. Mentions of keywords, hashtags, and keywords searched are recorded and Total Social Volume is provided by the platforms, e.g., Twitter, blogs, news articles.

Step 2:

Search & Social: These data are aggregated from search engines & social platforms (computer technology) into a computer program (for example, implemented on server 12) that contains all keyword volume.

Step 3:

Search: Searches are categorized into buckets, such as Recipes. Dozens of the highest searched keywords that fit into that category are shared for a given date range.

Social: Similar process. Mentions, hashtags, and keywords searched categorized into buckets with volume for that given date range.

Step 4:

Search & Social: Search & Social data outputs for the given date range may be reviewed. Trends are analyzed by a mix of volume & relevancy for each Search & Social partner, then are compared to one another. Volume is determined by the number of searches, or mentions, of a particular keyword or phrase. Relevancy is pre-determined as part of a category defined by Search & Social partners.

Results are triangulated to then analyze the results again by a mix of volume & relevancy across all search engines & Social platforms for that given date range.

If we are anticipating trends, the date range will be for a historical date range (e.g., the week leading up to Thanksgiving 2010-2014). Content will be advised based on recurring trends or an analysis of increasing trends that will likely be present again in the coming time period.

If we are changing content in real time, the date range will be for the immediate past (e.g., the past 7 days, yesterday, today, etc.) to advise altering content or promotion behind existing assets to be as relevant to the Search/Social discussions as possible.

Content informed is not limited to Search/Social, it expands to any organic or paid media assets, website content, etc.

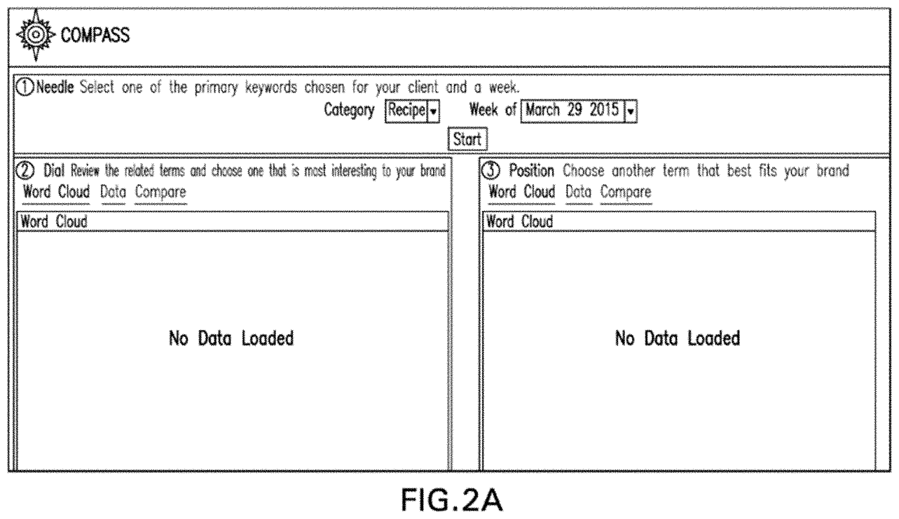

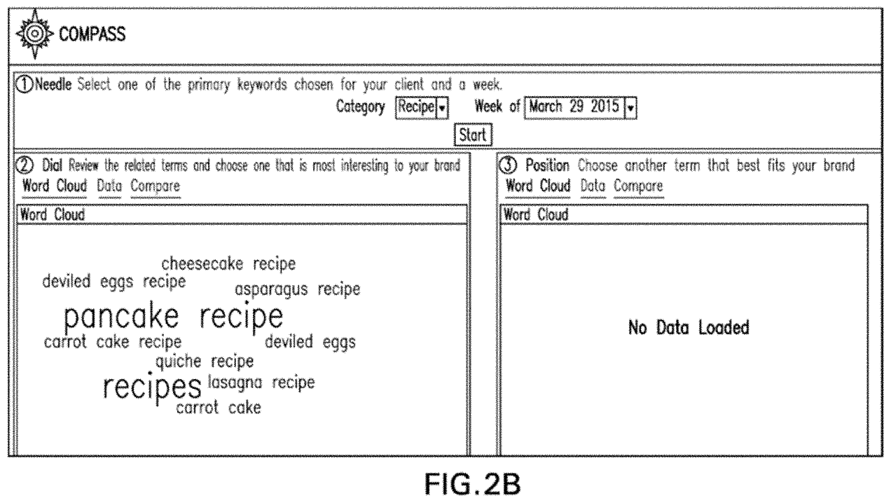

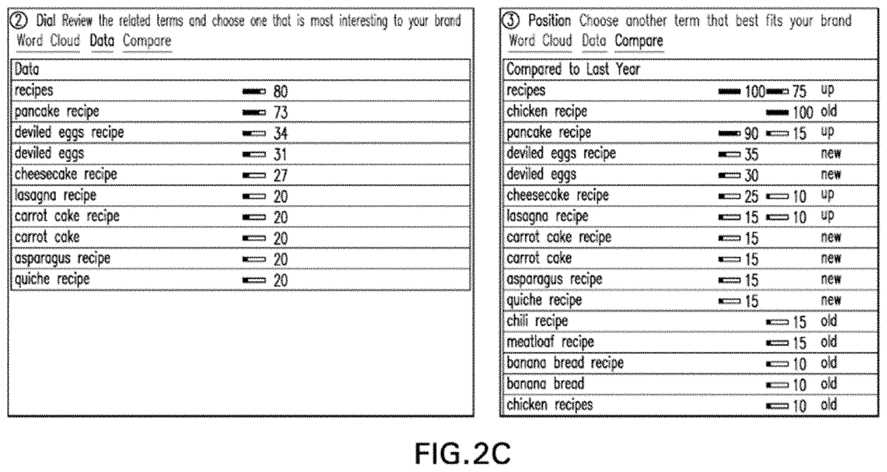

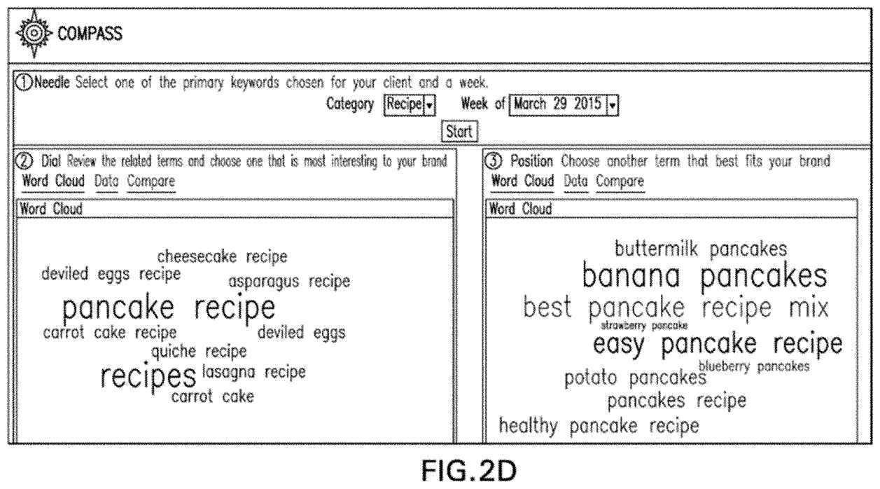

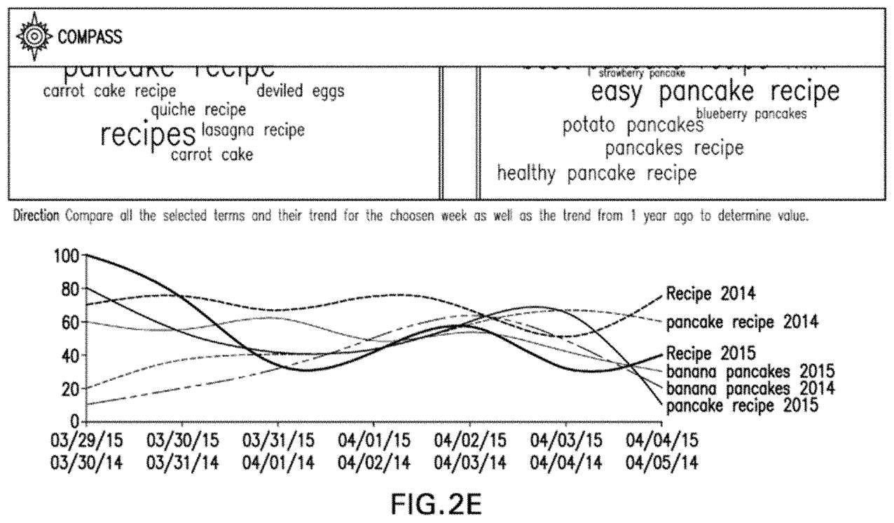

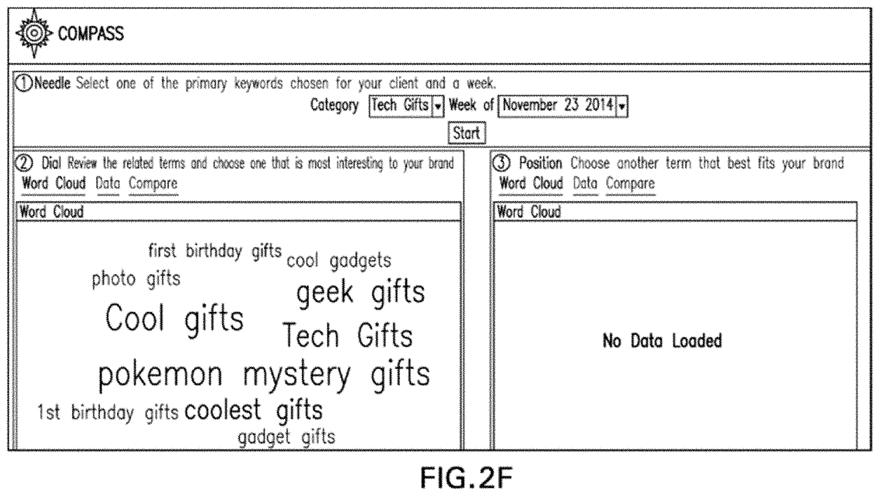

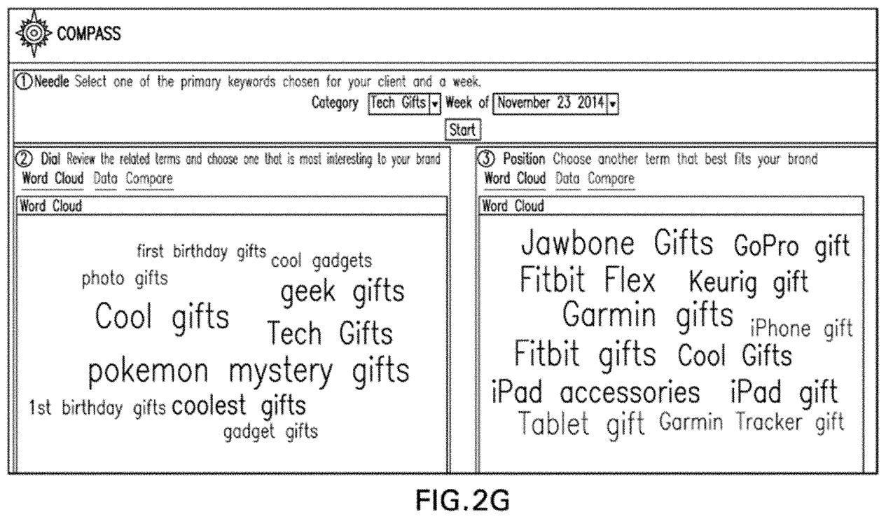

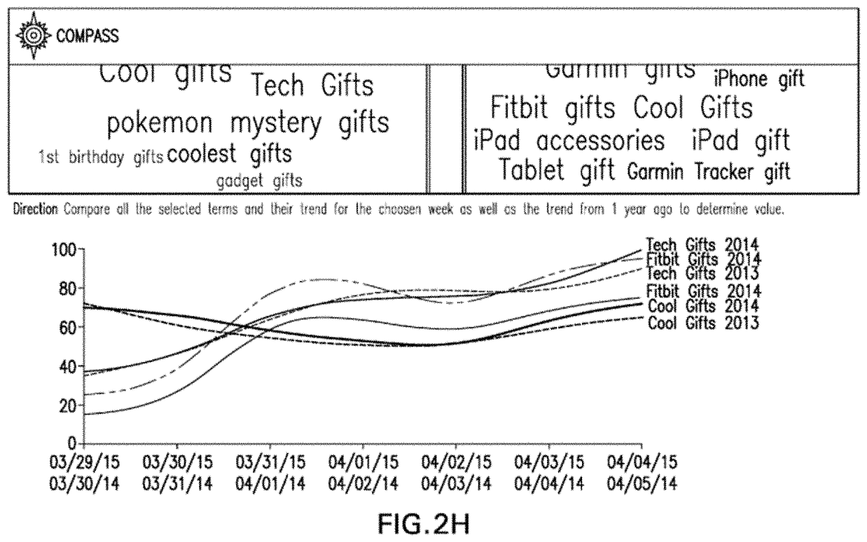

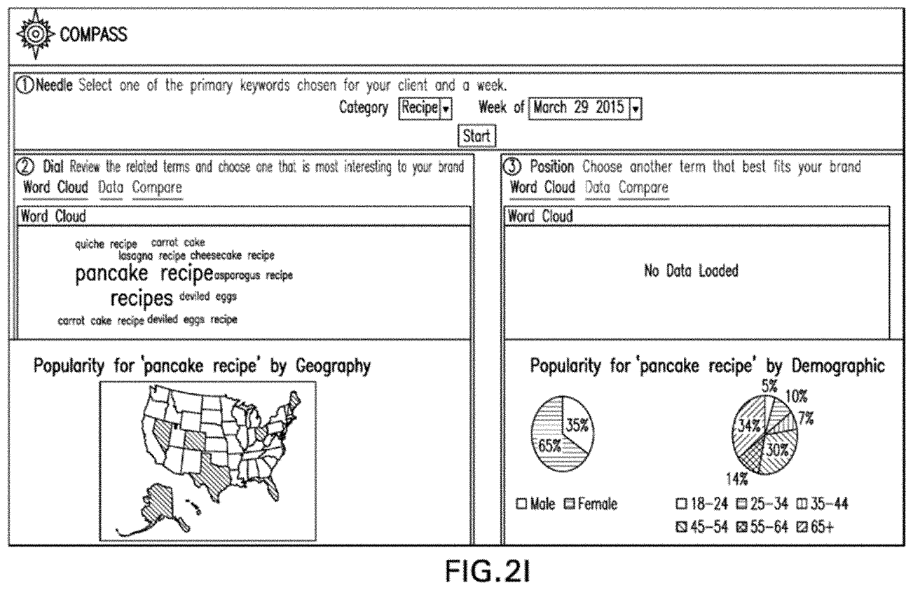

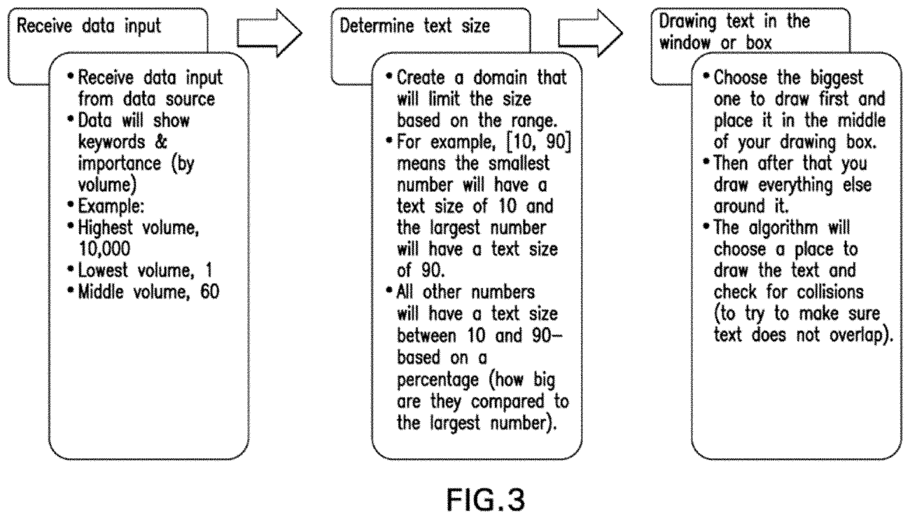

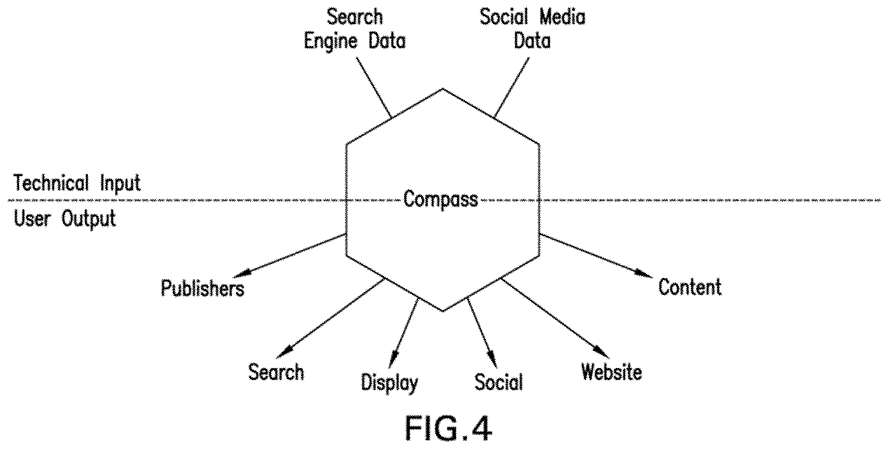

In using the system, categories of goods and services can be, but are not necessarily, predefined. A user selects a category and a date range of interest, for example via web browser. A screenshot of how these selections may be made is shown in FIG. 2A, where both the category(in this case, “Recipe”) and the date (the week of Mar. 29, 2015) may be selected via drop-down menu. FIG. 2B illustrates the results of this first step. As shown, the most relevant recipe (according to received search engine/social media, etc., data) are displayed in a word cloud, wherein the size, font, color, or placement of terms depends on their relevance. However, a word cloud is not the only form of output that can be generated by the system. FIG. 2C shows the output in simple “data” format (on the left), which just lists terms from the “recipe” category in terms of volume. In this example, the numbers 20, 27, 80, etc. represent the number of searches, or mentions, and are provided from Search & Social partners. The right side of FIG. 2C illustrates another example of how results can be displayed—as a comparison to the same term's relevance for the same period last year (as an example). As shown in FIG. 2D, an item in the word cloud (or other result format) can be selected by a user clicking on it. In this example, clicking on “pancake recipe” in the left part of the display results in a display showing the relative results of various kinds of pancake recipes in another word cloud as shown on the right side of the display. As before, the format of the result son the right side can be changed by clicking on “Data” or “Compare”.

As can be readily understood from the foregoing, trends in goods or services (or for that matter, recipes or other things) as revealed in search engines, social media or other sources, can be quickly and easily identified by using this system. Furthermore, performing the steps described above can further be used by server 12 or by the system to generate a third display that shows trends over time for the overall category, the first selected term, and the second selected term, as shown in FIG. 2E. FIGS. 2F through 2H illustrate similar concepts in the category of “Tech Gifts”.

FIG. 2I illustrates other displays that are possible with the system. Specifically, the geographic popularity for the term “pancake recipe” is shown at bottom left, while its popularity by demographic categories is shown at bottom right.

In other implementations of the inventions, the system may analyze conversation information from different audiences besides the keyword approach described herein. Also, external sources may receive conversation information, such as from search engines, social media, and eCommerce channels like Amazon or the like. In this case, taking the conversation from different audiences and keywords from each of these, weighing them to normalize the data, and then presenting them together and side-by-side to see what is trending for a given time period is desirable. The weighting of keywords here is similar to the process described herein. For example, one may assess conversations mothers with kids under the age of 5 are having on Facebook, what they're searching in Google, and what they're buying on Amazon.

Audience size & volume may differ depending on the platform, so one may normalize/index the data to ensure that scale is 1:1. If there is a significant amount of conversations about a topic like “Mom Jeans,” but they aren't driving sales on eCommerce retailers, one may approach that strategy differently than if the topic was also driving high sales volume. The external sources may provide the audience (conversations) and keyword raw data via application programming interfaces (APIs) as data sources.

One important aspect of this approach is assessing what the audience is talking about and using keywords without explicitly starting with a root keyword that would eliminate conversations happening outside of that root term. For example, if one begins with the keyword ‘recipes,’ one might notice that mothers with kids under 5 talked mostly about chicken recipes. But, if one looks at the overall audience, only one percent of this audience may have talked about chicken recipes. Rather, over fifty percent of this audience may have talked about growing their food in their garden—this would never show up if one would have started solely with a keyword approach.

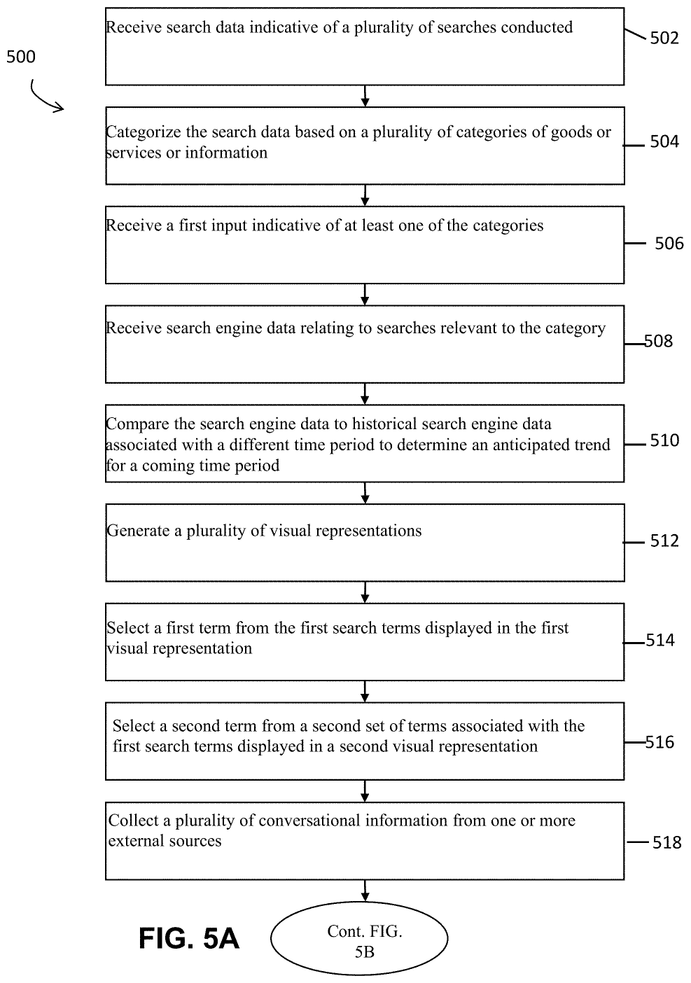

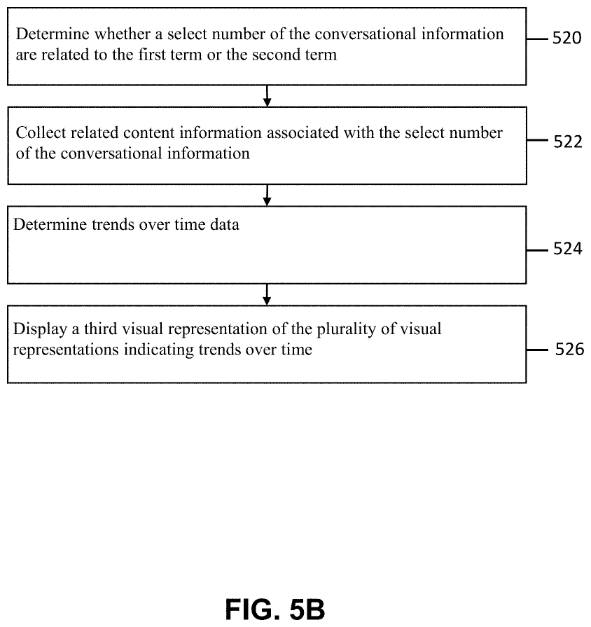

FIGS. 5A and 5B illustrate a flowchart of a computer-implemented method for identifying trends, according to one embodiment. In block 502, the method includes receiving search data indicative of a plurality of searches conducted. At block 504, the method includes categorizing the search data based on a plurality of categories of goods or services or information. At block 506, the method includes receiving a first input indicative of at least one of the categories. At block 508, the method includes receiving search engine data relating to searches relevant to the category, the search engine data comprising first search terms and first volume data for the first search terms.

At block 510, the method includes comparing the search engine data to historical search engine data associated with a different time period to determine an anticipated trend for a coming time period. The method includes generating a plurality of visual representations, wherein the first search terms are displayed in a first visual representation of the plurality of visual representations, as shown at block 512. Also, the method includes selecting a first term from the first search terms displayed in the first visual representation, as shown at block 514. At block 516, the method includes selecting a second term from a second set of terms associated with the first search terms displayed in a second visual representation of the plurality of visual representations.

At block 518, the method includes collecting a plurality of conversational information from one or more external sources. Moreover, the method includes determining whether a select number of the conversational information are related to the first term or the second term, as shown at block 520. Also, the method includes, in response to determining the select number of the conversational information are related to the first term or the second term, collecting related content information associated with the select number of the conversational information 522. At block 524, the method includes determining trends over time data from the results of comparing the search engine data to historical search engine data associated with the different time period and the related content information. At block 526, the method includes displaying a third visual representation of the plurality of visual representations indicating trends over time using the trends over time data.

In accordance with the principles of the present disclosure, once new trends are identified, such information may be used to inform recommendations for new products or services consistent with such trends. For example, after assessing the conversations and keywords of a particular topic, such as “Mom Jeans,” it may be determined that there is a new trend with moms having children under 5 years of age having the most interest in the product. As such, one may tailor their offering of “Mom Jeans” to that audience.

Provided with the present disclosure, those of ordinary skill in the art can readily prepare computer instructions to carry out the foregoing functions. Those of ordinary skill in the art will further realize that it is not always necessary that the functions described are performed in any particular order, or in any particular software module, or that the functions are even segregated into modules.

Exemplary embodiments of the present invention have been described above. Those skilled in the art will understand, however, that changes and modifications may be made to these embodiments without departing from the true scope and spirit of the invention, which is defined by the claims.

I claim:

1. A computer-implemented method for identifying trends, the method comprising:
receiving search data indicative of a plurality of searches conducted;
categorizing the search data based on a plurality of categories of goods or services or information;
receiving a first input indicative of at least one of the categories;
receiving search engine data relating to searches relevant to the category, the search engine data comprising first search terms and first volume data for the first search terms;
comparing the search engine data to historical search engine data associated with a different time period to determine an anticipated trend for a coming time period;
generating a plurality of visual representations, wherein the first search terms are displayed in a first visual representation of the plurality of visual representations;
selecting a first term from the first search terms displayed in the first visual representation;
selecting a second term from a second set of terms associated with the first search terms displayed in a second visual representation of the plurality of visual representations;
collecting a plurality of conversational information from one or more external sources;
determining whether a select number of the conversational information are related to the first term or the second term;
in response to determining the select number of the conversational information, collecting related content information associated with the select number of the conversational information;
determining trends over time data from the results of comparing the search engine data to historical search engine data associated with the different time period and the related content information; and
displaying a third visual representation of the plurality of visual representations indicating trends over time using the trends over time data.

2. The method of claim 1, further comprising:
receiving social network data comprising social volume data for social terms, and
weighting the plurality of the first search terms using the social volume data.

3. The method of claim 1, wherein the first visual representation comprises a first word cloud, with higher-weighted first search terms appearing larger than lower-weighted first search terms.

4. The method of claim 2, wherein the first visual representation comprises a first word cloud, with higher weighted first search terms appearing larger than lower weighted first search terms.

5. The method of claim 3, further comprising:
receiving a second input indicative of a user selection of the first term in the first word cloud;
receiving second search engine data relating to the second input, the second search engine data comprising the second set of terms and second volume data for the second terms;
weighting a plurality of the second set of terms based on at least the second volume data, wherein the second set of terms comprise a subcategory of the selected first term; and
generating the second visual representation comprising the second set of terms, wherein the second visual representation comprises a second word cloud, with higher weighted second set of terms appearing larger than lower weighted second terms.

6. The method of claim 4, further comprising:
receiving a second input indicative of a user selection of the first term in the word cloud;
receiving second search engine data relating to the second input, the second search engine data comprising the second set of terms and second volume data for the second terms;
weighting a plurality of the second set of terms based on at least the second volume data, wherein the second set of terms comprise a subcategory of the selected first term; and
generating the second visual representation comprising the second set of terms, wherein the second visual representation comprises a second word cloud, with higher-weighted second set of terms appearing larger than lower weighted second terms.

7. The method of claim 5, further comprising:
receiving a third input indicative of a user selection of the second term in the second word cloud; and
generating the third visual representation, wherein the third visual representation comprises a plurality of line graphs showing at least relative volume data for the category, the first term selected by the second input, and the second term selected by the third input.

8. The method of claim 6, further comprising:
receiving a third input indicative of a user selection of the second term in the second word cloud; and
generating the third visual representation, wherein the third visual representation comprises a plurality of line graphs showing at least relative volume data for the category, the first term selected by the second input, and the second term selected by the third input.

9. The method of claim 1, wherein collecting the conversational information comprises accessing the conversational information using one or more application programming interfaces.

10. The method of claim 1, wherein determining trends over time data comprises normalizing/indexing the results of comparing the search engine data to historical search engine data associated with the different time period and the related content information.

11. The method of claim 1, wherein displaying the third visual representation comprises displaying the related content information and the results of comparing the search engine data to historical search engine data associated with the different time period side by side.

12. A non-transient computer readable medium containing program instructions for causing a computer to perform the steps of:
receiving search data indicative of a plurality of searches conducted;
categorizing the search data based on a plurality of categories of goods or services or information;
receiving a first input indicative of at least one of the categories;
receiving a first input indicative of a category of goods or services or information;
receiving search engine data relating to searches relevant to the category, the search engine data comprising first search terms and first volume data for the first search terms;
comparing the search engine data to historical search engine data associated with a different time period to determine an anticipated trend for a coming time period; and
generating a plurality of visual representations, wherein the first search terms are displayed in a first visual representation of the plurality of visual representations;
selecting a first term from the first search terms displayed in the first visual representation;
selecting a second term from a second set of terms associated with the first search terms displayed in a second visual representation of the plurality of visual representations; and
collecting a plurality of conversational information from one or more external sources;
determining whether a select number of the conversational information are related to the first term or the second term;
in response to determining the select number of the conversational information, collecting related content information associated with the select number of the conversational information;
determining trends over time data from the results of comparing the search engine data to historical search engine data associated with the different time period and the related content information; and
displaying a third visual representation of the plurality of visual representations indicating trends over time using the trends over time data.

13. The non-transient computer readable medium of claim 12, wherein the steps further comprise:
receiving social network data comprising social volume data for social terms, and
weighting the plurality of the first search terms using the social volume data.

14. The non-transient computer readable medium of claim 12, wherein the first visual representation comprises a first word cloud, with higher-weighted first search terms appearing larger than lower-weighted first search terms.

15. The non-transient computer readable medium of claim 13, wherein the first visual representation comprises a first word cloud, with higher weighted first search terms appearing larger than lower weighted first search terms.

16. The non-transient computer readable medium of claim 14, wherein the steps further comprise:
receiving a second input indicative of a user selection of the first term in the first word cloud;
receiving second search engine data relating to the second input, the second search engine data comprising the second set of terms and second volume data for the second terms;
weighting a plurality of the second set of terms based on at least the second volume data, wherein the second set of terms comprise a subcategory of the selected first term; and
generating the second visual representation comprising the second set of terms, wherein the second visual representation comprises a second word cloud, with higher weighted second set of terms being larger than lower weighted second set of terms.

17. The non-transient computer readable medium of claim 15, wherein the steps further comprise:
receiving a second input indicative of a user selection of the first term in the word cloud;
weighting a plurality of the second set of terms based on at least the first volume data and the social volume data, wherein the second set of terms comprise a subcategory of the selected first term; and
generating the second visual representation comprising the second set of terms, wherein the second visual representation comprises a second word cloud, with higher-weighted second set of terms appearing larger than lower weighted second set of terms.

18. The non-transient computer readable medium of claim 16, wherein the steps further comprise:
receiving a third input indicative of a user selection of the second term in the second word cloud; and
generating the third visual representation, wherein the third visual representation comprises a plurality of line graphs showing at least relative volume data for the category, the first term selected by the second input, and the second term selected by the third input.

19. The non-transient computer readable medium of claim 17, wherein the steps further comprise:
receiving a third input indicative of a user selection of the second term in the second word cloud; and
generating the third visual representation, wherein the third visual representation comprises a plurality of line graphs showing at least relative volume data for the category, the first term selected by the second input, and the second term selected by the third input.

20. The non-transient computer readable medium of claim 12, wherein the steps further comprise:
receiving social network data comprising social volume data for social terms, wherein weighting the plurality of the first search terms includes using the social volume data; and wherein the first visual representation comprises a first word cloud, with higher-weighted first search terms appearing larger than lower-weighted first search terms.

21. The non-transient computer readable medium of claim 20, wherein the steps further comprise:
receiving a second input indicative of a user selection of the first term in the first word cloud;
receiving second search engine data relating to the second input, the second search engine data comprising the second set of terms and second volume data for the second terms;
weighting a plurality of the second set of terms based on at least the second volume data, wherein the second set of terms comprise a subcategory of the selected first term; and
generating the second visual representation comprising the second set of terms, wherein the second visual representation comprises a second word cloud, with higher weighted second set of terms appearing larger than lower weighted second set of terms.

22. The non-transient computer readable medium of claim 21, wherein the steps further comprise:
receiving a third input indicative of a user selection of the second term in the second word cloud; and
generating the third visual representation, wherein the third visual representation comprises a plurality of line graphs showing at least relative volume data for the category, the first term selected by the second input, and the second term selected by the third input.

23. The non-transient computer readable medium of claim 12, wherein collecting the conversational information comprises accessing the conversational information using one or more application programming interfaces.

24. The non-transient computer readable medium of claim 12, wherein determining trends over time data comprises normalizing/indexing the results of comparing the search engine data to historical search engine data associated with the different time period and the related content information.

25. The non-transient computer readable medium of claim 12, wherein displaying the third visual representation comprises displaying the related content information and the results of comparing the search engine data to historical search engine data associated with the different time period side by
